(19) United States
(12) Patent Application Publication
(10) Pub. No.: US 2009/0273712 A1
(43) Pub. Date: Nov. 5, 2009

(54) SYSTEM AND METHOD FOR REAL-TIME SYNCHRONIZATION OF A VIDEO RESOURCE AND DIFFERENT AUDIO RESOURCES

(76) Inventor: Elliott Landy, Woodstock, NY (US)

Correspondence Address: LEIGHTON K. CHONG;PATENT ATTORNEY, 133 KAAI STREET, HONOLULU, HI, 96821, US

(21) Appl. No.: 12/113,800

(22) Filed: May 1, 2008

(51) Int. Cl. H04N 9/475

(52) U.S. Cl. 348/515; 348/E09.034

(57) ABSTRACT

An audio-visual system and method employs a dual-control interface for directly controlling the video speed of an underlying video resource for video output, and for switching among any of a plurality of audio resources at different points in time independently of the video output. The video speed control allows a user to adjust the running speed of the video track to match or synchronize with the tempo or duration of a selected audio track at any point in time. The video speed and audio selection commands can be recorded and distributed on disk along with the audio-video application and underlying video and audio tracks. It can thus be operated for play on PCs or game consoles, or used as media for play on wireless mobile devices or Internet browsers. The audio-visual system is particularly suitable for making personally editable music video and/or playing video games, audience participation (karaoke) games, and the like.

### TECHNICAL FIELD

This invention generally relates to a computerized system and method for creating and playing back multimedia programs, and particularly to tools for synchronizing the video and audio content in multimedia programs.

### BACKGROUND OF INVENTION

Multimedia programs that composite multiple sources of video and audio content in a final program typically require powerful audio/video formatting tools and editing systems to produce a finished program of video synchronized to audio. Raw video resources are converted to digital video format and desired video segments are digitally spliced on a video editing track. Similarly, raw audio resources are converted to digital audio and desired segments are digitally spliced on one or more audio editing tracks. The typical editing system enables the editor to adjust the playback speed of video segments on the video track relative to the speed and start/stop times of audio segments on the audio track in order to render the video and audio in synchronism with each other to produce a pleasing effect on the viewer/listener. However, due to the powerful tools used to produce seamless digital splicing of audio and video segments and fine adjustments for synchronization, the finished multimedia program can only be modified by re-editing on the editing system, and the underlying content for the video and audio segments cannot be accessed or changed directly.

Existing video editing and audio/video systems can typically be divided into linear and non-linear systems. Non-linear systems are capable of processing audio and video in any arbitrary order, whereas linear systems process audio and video in the order it was initially recorded and only in that order. Linear systems can further be divided into real time and non real time systems. Real time linear systems are capable of processing such audio and video at the same speed in which it was recorded, whereas linear systems which are unable to process audio and video at that speed are termed non real-time systems.

Examples of audio/video editing systems in the prior art are shown, for example, in U.S. Pat. No. 5,237,648 to Mills et al. which discloses an editing system with a control interface having a slider bar for controlling playback speed in combination with radio buttons to control the playback of video and audio tracks. US Published Patent Application 2002/0161794 and U.S. Pat. No. 7,076,495 to Dutta et al. show a media playback device with playback controls to manipulate the playing back of stored captured screen images at a rate chosen by the user, such as for playing at a slower rate for users having cognitive disabilities. A sliding bar control can be set by the user to set the speed at which successive screen images are displayed. US Published Patent Application 2003/0122862 to Takaku et al. shows a multimedia editing and playback system for editing and playing back intermediate and final results of the editing process. An edit instruction unit has a control interface for inputting user's edit selections and issuing edit operating instructions. US Published Patent Application 2003/0146915 to Brook et al. shows a multimedia editing system with a graphical user interface (GUI) that includes a video/still image viewer window and a synchronized audio player device. The GUI system has a simplified time-line, containing one video-plus-sync audio track, and one background audio track, where the two audio tracks can be switched to be visible to the user. Audio clips can be selected in a sequence, or can be dragged and dropped onto a playlist summary bar for use in creating a sequence of audio segments.

Examples of synchronization methods in prior systems are shown, for example, US Published Patent Application 2004/0027369 to Kellock et al. which discloses an editing system for automatically editing motion video, still images, music, speech, sound effects, animated graphics and text. The timing of events within the video can be synchronized with the beat of the music or with the timing of significant features of the music. US Published Patent Application 2004/0267952 to He et al. discloses a multimedia editing system with variable play speed controls for media streams including a built-in streaming media platform enabling third party developers to access and take advantage of the variable play speed control, and the ability to implement variable play speed control on media streams from a variety of sources including streaming media servers. U.S. Pat. No. 6,414,686 to Protheroe et al. discloses a multimedia editing system the editor uses interface controls to play a selected video clip using sliders to control the playing rate of the video. US Published Patent Application 2005/0275758 to McEvilly et al. discloses a playback control unit for controlling the playback of video content on a network by checking the contents schedule to ensure that the requested playback control is not prohibited and, if it is not, uses tag data associated with the content being streamed to control the data that is streamed to the user.

US Published Patent Application 2006/0129933 to Land et al. shows a system for creation and presentation of multimedia content, such as greetings, slideshows, websites, movies and other audio-visual content. The playback controls allow for speed of change, degree of change, various other options, etc. The default settings for these parameters may be randomized to provide a variety of behaviors. US Published Patent Application 2006/0271977 to Lerman et al. discloses video editing through a server application in which a self-contained editing software is embedded in the user's browser. The playback controls include a fast-forward feature, a rewind feature, a pause feature, stop feature, a record feature, an on/off feature, a rate feature, a transmission feature, and other playback control features. US Published Patent Application 2006/0009983 to Magliaro et al. discloses a system for controlling the playback rate of real-time audio data received over a network

Also, U.S. Pat. No. 6,762,797 to Pelletier discloses a playback interface configured to control playback speed of video and audio streams provided to a viewing device from a storage mechanism in accordance with accelerated playback speed. US Published Patent Application 2007/0260690 to Coleman discloses an editing system with synchronization controls for different types of media that may be on different tracks or played from an external source. For External Synchronization of multiple threads, the starting time for all media types is strictly synchronized and each thread plays independently based on the associated media types. Users may use the play controller to change the position or rate of video playing.

Examples of still-image video usage in prior systems include, for example, US Published Patent Application 2005/0066279 to LeBarton et al. shows a system for capturing still images and playing back in sequential series. The user can record audio and/or insert sound effects and music accompaniment to play along with the still-image animation. US Published Patent Application 2005/0231513 to LeBarton et al. shows a stop-motion video editing system in which the frame rate of the movie can be changed at any arbitrary point by changing the frame hold time. Audio is added and synchronized to the animation by inserting an audio cue at a desired frame within the animation to start playing at that frame. U.S. Pat. No. 6,735,253 to Chang et al. shows a system for editing video over a network that has a tool for variable speed playback, and another tool for strobe (still-image) motion that is a combination of freeze frame and variable speed playback.

Existing audio/video editing systems are explicitly designed to maintain fixed synchronization between the underlying audio and video tracks, so that the end result is a program in which video and audio streams are synchronized together and play together “in lockstep.” In a typical implementation, timecode values are stored in both the audio and video streams. These timecode values are used by the playback engine to maintain synchronization between the video and audio tracks during the playback of said video and audio tracks. These timecode values may either reflect a common time base, such that the timecodes within the audio tracks are directly comparable to the timecodes within video tracks, or the audio timecodes may be offset from the video timecodes by a fixed value. In either case, a single incrementing time counter can be used to maintain synchronization between the audio and video during playback. Thus, the audio and video are kept in synchronization both with respect to each other and to a single master time counter.

However, the prior types of audio/video editing systems do not enable a user to edit or playback an audio-visual program directly from the underlying video and audio resources while synchronizing the video and the audio independently of each other in real-time in a simple manner using easy-to-operate interface controls. The end result of a typical audio/video editing system is a final product that is disconnected from the underlying resources. The existing editing systems save the results of the editing process as a work-in-progress in which the selected video and audio segments are excerpted from the underlying video and audio resources. They do not allow the user in re-editing or playback modes to adjust the video speed of the underlying video resource while simultaneously switching among multiple underlying audio resources in order to aesthetically match the video to the audio in real-time.

### SUMMARY OF INVENTION

In accordance with the present invention, an audio-video system operable on a computer device comprises:

a) a video controller for running an underlying video resource composed as a series of digital image frames of visual content for video output;

b) an audio controller for running a plurality of underlying audio resources and selectively switching among them for audio output, wherein any one of the underlying audio resources can be selectively switched by the audio controller for audio output; and

c) a dual-control interface operable by a user of the system for controlling the underlying video resource and plurality of audio resources, wherein said dual-control interface includes a video speed control for providing a video speed command to the video controller for adjusting the running speed of digital image frames of visual content from the video resource at any point in time, and an audio selection control for providing an audio selection command to the audio controller for selectively switching to any one of the plurality of underlying audio resources for audio output at any point in time independently of the video speed control.

The video speed control adjusts the running speeds of the video at different points in time of the underlying video resource. Independently, the audio selection control switches to any of the underlying audio resources at different points in time for the audio output. The user can adjust the running speed of the underlying video resource independently of the running speed of the underlying audio resources which are selected to play at different points in time, thus allowing the user to independently synchronize the audio and video resources and enabling the audio and video resources to play back at different rates from each other. The dual-control interface for the system can be played extemporaneously for composing in real-time. It can also be used to edit an AUDIO/VIDEO program so that the video speed and audio selection commands can be recorded as an output file for playback. The recorded script of video speed and audio selection commands can be played back to control the underlying video and audio resources in real-time. Modifications to the audio-video program can be made simply by modifying in real time the commands that call the various underlying video and audio resources into use.

The audio-video system of the invention can use a raw video resource or one that has been edited from one or more raw video resources and converted to digital format for use in the system. Similarly, the user can use pre-recorded audio resources or even live audio input as an audio resource which may or may not be recorded by the user and saved into the application file. The user operates the dual-control interface to select the audio resource to be played at any point in time while adjusting the speed of the video to aesthetically match it. For example, the video speed can be adjusted to run slower if a song with a slow beat is selected for playing, and adjusted to run faster if a song with a fast beat is selected for playing. The user can thus independently synchronize the video track such that it aesthetically matches any selected audio track in real-time using the dual-control interface.

The audio tracks may be short segments that are run by clicking on a selection button on the control interface. Alternatively, they may be long-format audio or looped track, and can be cued to all start together at the same time and switched to run at different points in time of the program. A cuing control is used for cuing the plurality of audio resources to run together so that the user can quickly hop from one running audio track to another to play different songs, cadences, or audio themes that go together with different topics or themes shown in the video track.

The audio and video can thus be independently synchronized simply by operating the video speed control and the audio selection control linked to the underlying video and audio resources. The direct control of underlying resources enables composing, editing, re-editing and playback to be performed on the same system using the same control interface. This avoids the need to have modifications to the program done through a full-function editing system, and enables the system to be used extemporaneously for personal entertainment and music video games in which the user can compose their own programs and modify them in real-time at will.

In a particularly preferred embodiment, the video is in the form of a series of still-image frames from stop-motion photography. Playback of the still-image frames creates the effect of a strobe or animation video. Adjusting the running speed of the still-image frames faster or slower is absorbed by human perception as an increase or decrease in tempo while hopping among different audio tracks. In contrast, changing the speed of full-motion video would be perceived as speeded-up or slow-motion video. Constantly shifting between speeded-up or slow-motion video can become tiring or objectionable to human perception. Changing the running speed of still-image photo frames is perceived as less objectionable to human perception, and therefore is preferred for use with the video speed control in the invention system.

The video speed and audio selection commands can be recorded and distributed on disk along with the audio-video application and underlying video and audio tracks. It can thus be operated for play on PCs or game consoles, or used as media for play on wireless mobile devices or Internet browsers. The audio-visual system is particularly suitable for making personally editable music video and/or playing video games, audience participation (karaoke) games, and the like.

The present invention thus provides the real-time ability to adjust the speed of a video resource independently of the audio resource selected, while simultaneously allowing the user to switch among any of a multiple of audio tracks. The audio and video resources are deliberately not locked in synchronization with each other, but in fact each can be adjusted/selected independently. This is in contrast to conventional audio-video editing systems which are designed to maintain synchronization between audio and video tracks, so that the end result is a program in which video and audio streams are synchronized together and play together “in lockstep.”

Other objects, features, and advantages of the present invention will be explained in the detailed description below with reference to the following drawings.

### BRIEF DESCRIPTION OF DRAWINGS

FIG. 1 is a schematic diagram of a system and method for synchronizing a video track to aesthetically match different audio tracks, in accordance with the present invention.

FIG. 2A illustrates an example of the process steps for use of the invention system.

FIG. 2B illustrates a state diagram of control instructions selected by the user in an example of adjusting the video speed to aesthetically match different audio tracks.

FIG. 3 illustrates the same example in a time sequence diagram.

FIG. 4 shows an example of the editor/player display, audio track selection box, and speed adjustment box looks in an example of the control interface.

FIGS. 5-9 are schematic diagrams illustrating tools and options in an example of the control interface for the editor/player.

FIG. 10 shows a dialog box for setting general preferences for the audio-video program.

FIG. 11 shows a dialog box for setting default directories for the audio-video program.

### DETAILED DESCRIPTION OF INVENTION

In the following detailed description, certain preferred embodiments are described as illustrations of the invention in a specific application or computer environment in order to provide a thorough understanding of the present invention. Those methods, procedures, components, or functions which are commonly known to persons of ordinary skill in the field of the invention are not described in detail as not to unnecessarily obscure a concise description of the present invention. Certain specific embodiments or examples are given for purposes of illustration only, and it will be recognized by one skilled in the art that the present invention may be practiced in other analogous applications or environments and/or with other analogous or equivalent variations of the illustrative embodiments.

Some portions of the detailed description which follows are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “computing” or “translating” or “calculating” or “determining” or “displaying” or “recognizing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

A computer or computing resource commonly includes one or more input devices electronically coupled to a processor for executing one or more computer programs for producing an intended computing output. The computer is typically connected as a computing resource and/or communications device on a network with other computer systems. The networked computer systems may be of different types, such as remote PCs, master servers, network servers, and mobile client devices connected via a wired, wireless, or mobile communications network.

The term “Internet” refers to a structure of global networks connecting a universe of users via a common or industry-standard (TCP/IP) protocol. Users having a connection to the Internet commonly use browsers on their computers or client devices to connect to websites maintained on web servers that provide informational content or business processes to users. The Internet can also be connected to other networks using different data handling protocols through a gateway or system interface, such as wireless gateways using the industry-standard Wireless Application Protocol (WAP) to connect Internet websites to wireless data networks. Wireless data networks are now deployed worldwide and allow users anywhere to connect to the Internet via wireless data devices.

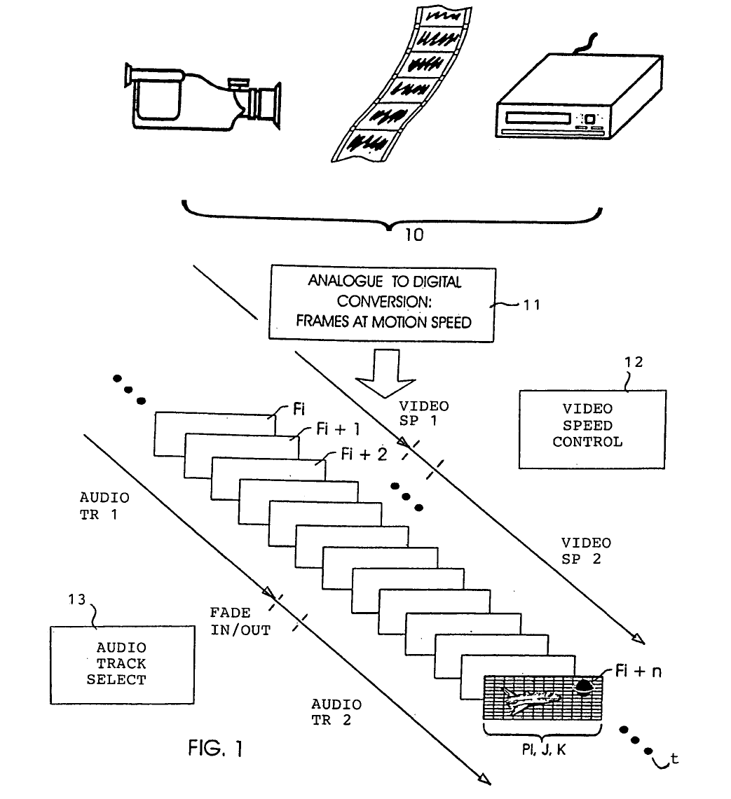

FIG. 1 shows a schematic diagram of the basic process steps for the audio-video system and method of the present invention. Video content from video sources 10, such as raw or edited footage from a videocam, or a series of still-image photographs, or video from a CD or DVD player, is captured and/or converted to a digital video file in a capture/conversion step 11. The digital video file consists of a series of image frames Fi, Fi+2, Fi+3, . . . , Fi+n, in a time sequence t. Each image frame F has a frame address i, i+1, i+2, . . . , i+n corresponding to its unique position in the sequence. Particular image frames may be identified as representing turning points in the multimedia program, such as an incident (PI), scene change (J), or thematic change for music (K). These turning points can be used by a user as editor to address the points at which different audio tracks are to be introduced.

The system includes at least two types of controls in a dual-control interface. A video speed control 12 enables the user to adjust the speed (frame rate) of the video track to different speeds. In the diagram, a video track is shown running at a first speed (SP 1), then is adjusted by the video speed control 12 to run at another speed (SP 2). A short transition period, which may be near instantaneous so as to be imperceptible, or may be a longer fade in/out type of transition, is indicated (in dashed cross-hatch lines) for the adjustment from Video Speed 1 to Video Speed 2. As a further option, the system may be configured to use dual video tracks, each with its own speed control and the capability to superimpose them on one another.

An audio selection control 13 enables the user to select among different audio tracks to run at different points in time of the running of the video track. In the diagram, a first audio track (TR 1) is selected by the selection control 13 to run with the video track at frame Speed 1, then a second audio track (TR 2) is selected to run with the video track at the frame Speed 2. A short transition period is also indicated (by dashed cross-hatch lines) for the switch from Audio Track 1 to Audio Track 2. In this manner, different audio tracks can be selected for play by the selection control 13 for different incidents, scenes, or themes depicted in the video track, and simultaneously the video speed can be adjusted by the video speed control 12 to run faster or slower to match the tempo or length of the audio track. With simply these two controls, the system can change audio segments and adjust their synchronization to the video directly from the underlying audio and video tracks. In effect, switching among audio tracks is like playing a medley of songs or tunes at will, and adjusting the speed of the video frames is like playing an instrument for visuals.

For raw footage that is full motion video, a sequence of 30 image frames is typically generated per second of video. However, the video file may be created as a series of still-image frames from stop-motion photography. Playback of such still-image frames creates the effect of a strobe or animation video which, when adjusted to run at faster or slower frame speeds, can be absorbed by human perception as an increase or decrease in tempo. In contrast, changing the speed of full-motion video would be perceived as shifting between speeded-up and slowed-down video, which can become tiring or objectionable to human perception. Changing the running speed of still-image photo frames is perceived as less objectionable to human perception, and therefore is preferred for use with the video speed control in the invention system. A “skip frame” feature (skipping every i-th frame) may be provided to make normally-shot videos seem more strobe-like and have a better visual effect in this system.

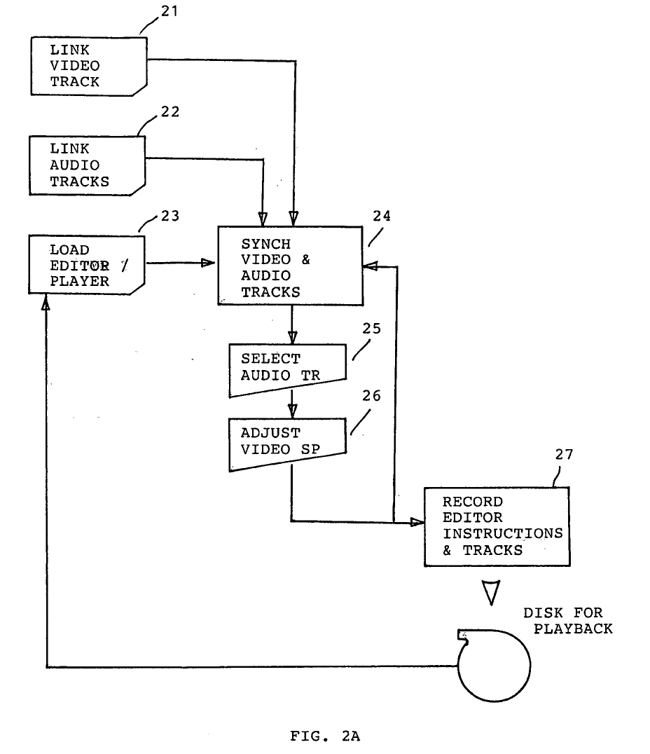

FIG. 2A illustrates the functional sequence for use of the invention system. In Step 21, the user links an video resource (file) to the system that has been captured or composed from one or more video resources for use in the program. In Step 22, the user links several audio resources (songs, recordings, microphone input) for use in the program. Live audio input may be used as one of the audio resources, and may be recorded by the user and saved as an audio resource file. In Step 23, the user loads editor/player system software on the computer, player, or other client device for running the audio-video program. As the editor/player software primarily operates simple video speed and audio track selection controls that work directly with underlying audio and video resources, the software footprint can be made very small for use on thin client devices and game consoles. In Step 24, the user operates the editor/player dual-control interface to select an audio track (at Step 25) from the several tracks linked to the program and to adjust the speed of the video track (at Step 26) to synchronize its frame rate with the tempo or length of the currently selected audio track. The control instructions used to control the audio and video tracks are recorded (at Step 27) as the session progresses, and the control sequence loops for each further audio track selection and/or video speed adjustment until the end of the program is reached. When the program is completed, the control commands and underlying audio and video resources can be recorded on a CD or DVD disk for re-editing or playback on a computer, mobile device, internet, etc. For playback, the process returns to the beginning for linking the video track and selected audio tracks with the editor/player software.

During playback, the audio track group and the video track play independently of one another. The audio plays at the constant rate at which it was recorded. The video plays at a rate which corresponds to the playback speed selected by the user. The relationship of when the audio starts to play, in reference to the beginning of the timeline, is set when the user loads the audio file. At the time the audio track is loaded, the user selects the position in the timeline at which the audio track will start to play. Prior to that point in the timeline, that particular audio track will be silent.

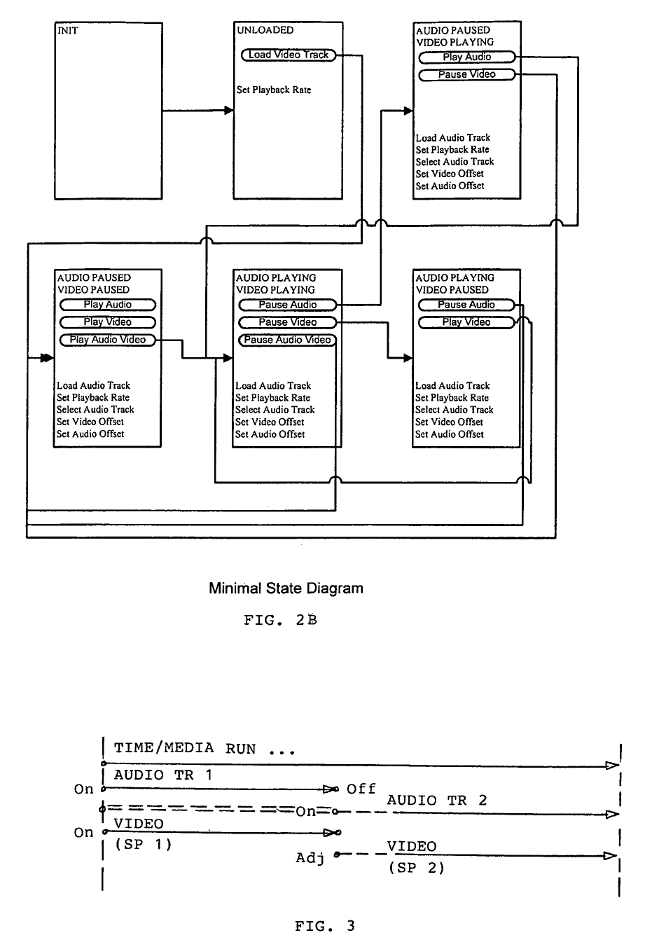

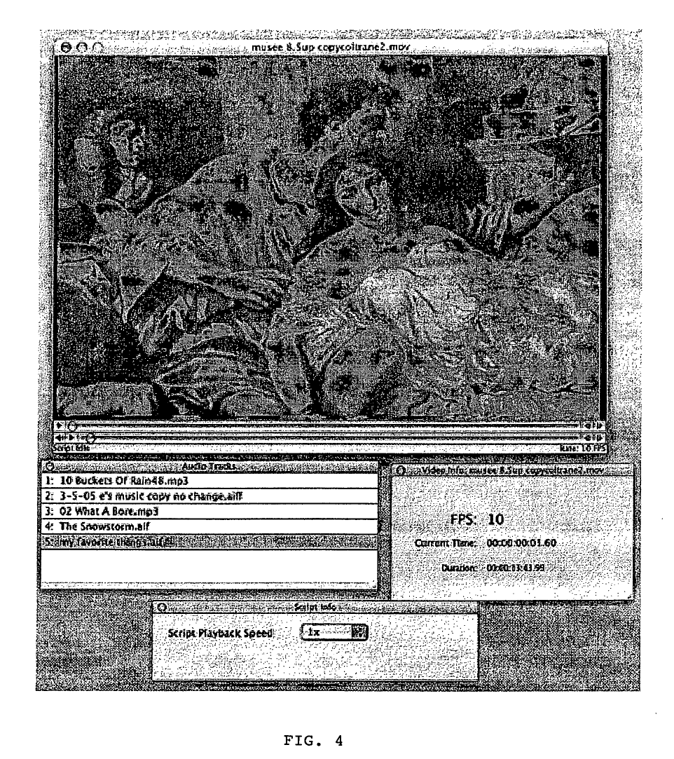

FIG. 2B illustrates a state diagram of control instructions input by the user, for example, for selecting an Audio Track 1 and adjusting the video speed to aesthetically match it, then selecting an Audio Track 2 and adjusting the video speed to aesthetically match it (to be described in further detail below). FIG. 3 illustrates this same process in a time sequence diagram. FIG. 4 shows an example of how the editor/player display may look with the current audio track selection highlighted in an audio track selection box and the current video speed displayed along with a speed adjustment box (script playback speed).

### Software Implementation of Preferred Embodiment

In an example of a preferred embodiment, RealBasic objects and the Apple QuickTime API are used to implement many of the features of the invention, including the parsing of audio and video files and playback of audio and video streams. Two QuickTime movies are used. The first is the video movie, which is used to contain and control the video track. The second is the audio movie, which is used to contain and control the audio tracks. The audio “movie” switches between audio tracks by selectively enabling one of the tracks and disabling the rest. Even though only one track can be heard at a time, they are essentially all playing simultaneously. Each audio track may contain one or more audio streams, for example a stereo sound track.

Two independent playback timers and two independent rate calculations are used to maintain independent synchronization of the audio and video tracks, enabling the audio and video tracks to play back at different rates. Video playback is synchronized using the video playback timer and the video rate calculation. Each frame of video is maintained on screen for a duration that is determined by the current video playback rate. Audio playback synchronization is handled by QuickTime, using an audio timer and a rate calculation which are independent of their video counterparts. During playback, each of the loaded audio tracks is synchronized to each other and the audio playback timer. Even though only one audio track can be heard at a time, they are essentially all playing simultaneously.

The application software begins executing once it is partially or completely loaded from the storage device into local memory.

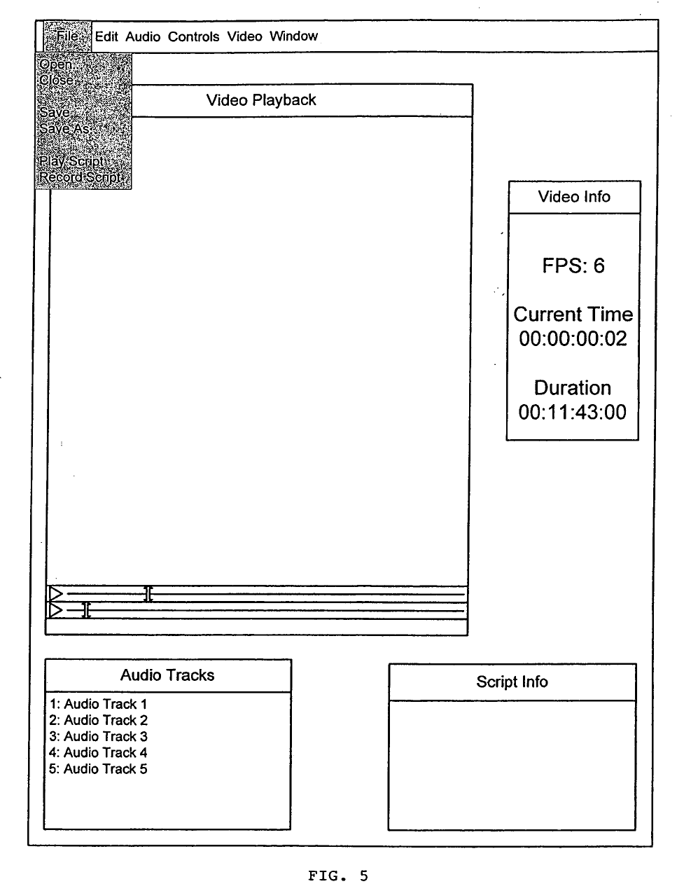

A control interface for the editor/player is presented to the user on the display for the PC, player or other client device, as illustrated for example in FIGS. 5-9. The initial display consists of a menu, audio track selection window, video info window, and script info window. Dialog boxes are also displayed to the user at various times in response to user actions. For use of the player/editor in the PC environment, the user may interact with the system using a keyboard and/or mouse. Menus are used to present various options to the user and they may be invoked either by pointing to and clicking on them with the mouse or by using various keyboard keys.

In FIG. 5, from the “File” menu, the user may choose “Open . . . ”, to open a video file or “Close”, to close an already opened video file. If the user clicks on the “File” menu and selects the “Open . . . ” option, a standard file selection dialog box is then presented to the user within which the user is able to select a movie file to be opened. Once the movie file is selected, the user clicks on the open button, at which point the dialog box is closed and a new video playback window is opened. The first image contained in the video file is displayed in this new video window, therefore giving the user an initial visual representation of the video file. If there are any audio tracks contained in the movie file then the names of each of the audio tracks is added to the audio tracks selection window. There may be multiple video tracks (channels) as well.

In FIG. 5, from the “File” menu, the user may select various file management functions, such as “Open”, “Close”, “Save”, “Save As”, “Play Script” and “Record Script”.

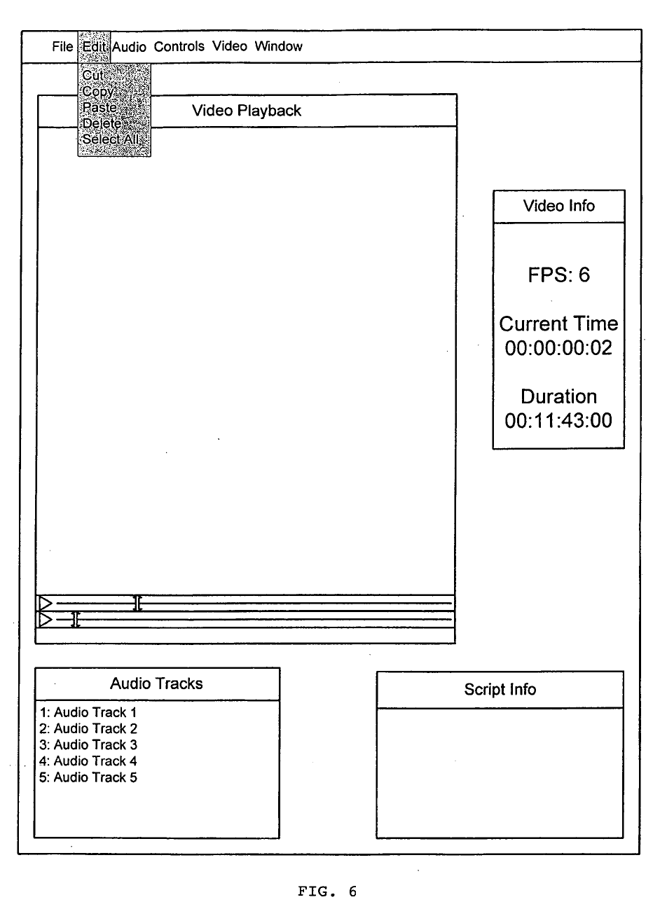

In FIG. 6, from the “Edit” menu, the user may select from among various AUDIO/VIDEO file editing functions.

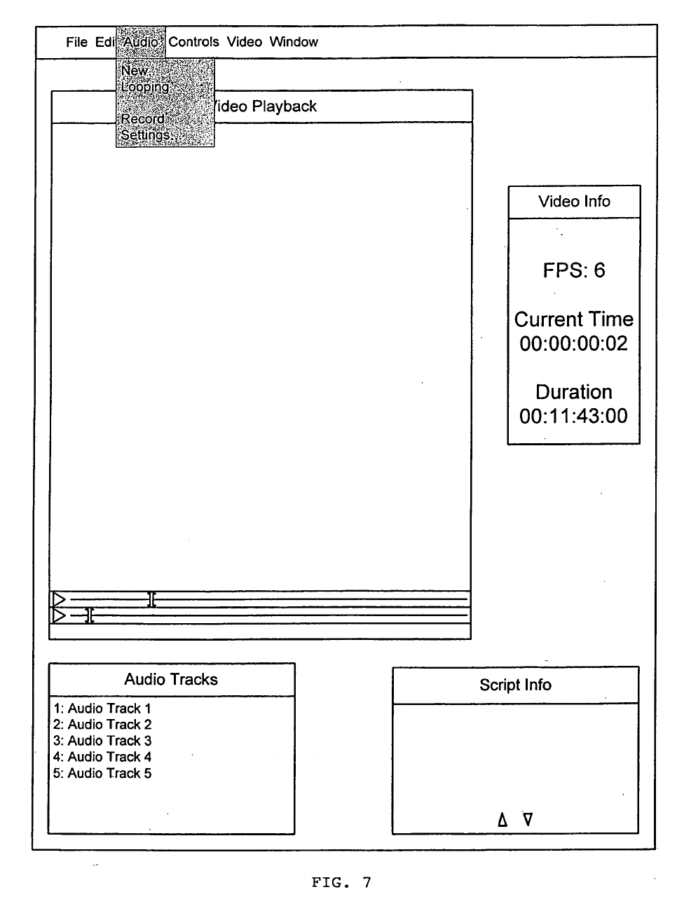

In FIG. 7, from the “Audio” menu, the user may select the “New . . . ” option, to open an additional audio file. The “New . . . ” option is only selectable after a video file has been loaded. If the user clicks on the “Audio” menu and selects the “New . . . ” option, a dialog box is presented to the user allowing them to choose between two options: “Insert at the beginning” or “Insert at the current position.” If “Insert at the beginning” is chosen, the initial offset of the newly opened audio track is set to zero. If “Insert at the current position” is chosen, the initial offset of the newly opened audio track is set to the current audio time index. Once the user chooses one of the two options, this initial dialog box is closed and a standard file selection dialog box is then presented to the user within which the user is able to select an audio file to be opened. Once the audio file is selected, the user clicks on the open button, at which point the file selection dialog box is closed and the names of each of the audio tracks contained in the selected audio file is added to the audio track selection window. Additional audio tracks can be loaded by repeating this procedure for each audio track. Audio may also be dragged and positioned either at the beginning of a movie or at a user determined point in the movie time line.

After a video track and one or more audio tracks are loaded, the user can choose to play the video and audio by pressing the “space bar” key, at which point the video movie and the audio movie will begin playing. Each frame of video from the video movie is sequentially displayed within the video window. The rate at which the frames are displayed is controlled by the current setting of the video playback rate. Pressing the “space bar” key toggles between the playback state, where the video track and audio track are being played back, and the paused state, where video track and audio track are both paused. Alternatively, the user may choose to play only the video track by selecting the “Play/Pause” icon on the video playback timeline. The video track may be toggled between the play and paused states by selecting the “Play/Pause” icon. Similarly, the user may choose to play only the audio track by selecting the “Play/Pause” icon on the audio playback timeline. The audio track may be toggled between the play and paused states by selecting the “Play/Pause” icon.

The current playback position of the audio track can be changed independently of the current playback position of the video track by dragging icons and repositioning them in relationship to one another. Alternatively, the current playback position of the audio track can be changed simultaneously with the current playback position of the video track by dragging both icons together.

In the preferred embodiment, only one audio track is audible at any given time. All other audio tracks are silent. The currently selected audible audio track will play back at the playback rate that is indicated by the selected audio track's file metadata, which is typically the rate at which the audio track was recorded. Thus, playback of the selected audio track will occur at normal speed. However, playback of the video track will proceed at the currently selected video playback rate, which is user configurable.

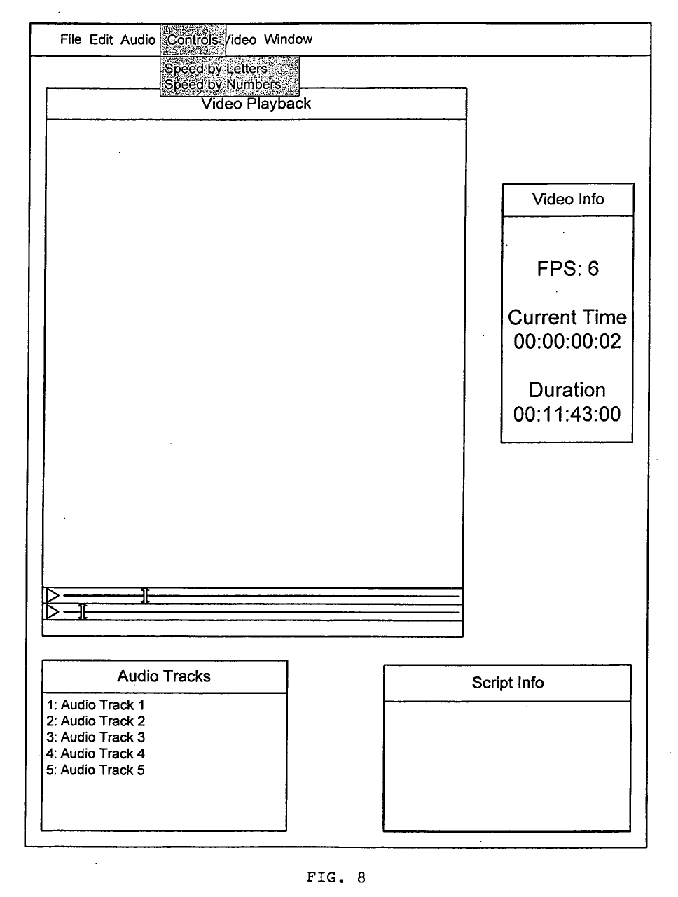

In FIG. 8, from the “Controls” menu, the user may select to input instructions for video speed adjustment by “Letters” or “Numbers”. For example, the user can adjust the video playback rate using letter keyboard commands such as:

“z”—Set video playback rate to 1 frame per second.

“x”—Set video playback rate to 2 frames per second.

“c”—Set video playback rate to 3 frames per second.

“v”—Set video playback rate to 4 frames per second.

“b”—Set video playback rate to 5 frames per second.

“n”—Set video playback rate to 6 frames per second.

“m”—Set video playback rate to 7 frames per second.

In the above case, when the user has selected to control the speed of playback by letters, then the number keys control the selection of audible audio tracks.

“1”—Only track 1 is audible.

“2”—Only track 2 is audible.

“3”—Only track 3 is audible.

etc.

Conversely, the user can select to control the playback speed by numbers, and the letter keys can be used to control which audio is made audible.

Additional video playback rates are also selectable by using additional keyboard commands which are not listed here. If the video is currently playing when a change is made to the video playback rate, then such a change takes effect immediately and is immediately visible in the playback window, otherwise the video playback rate is stored for later use once the video playback begins.

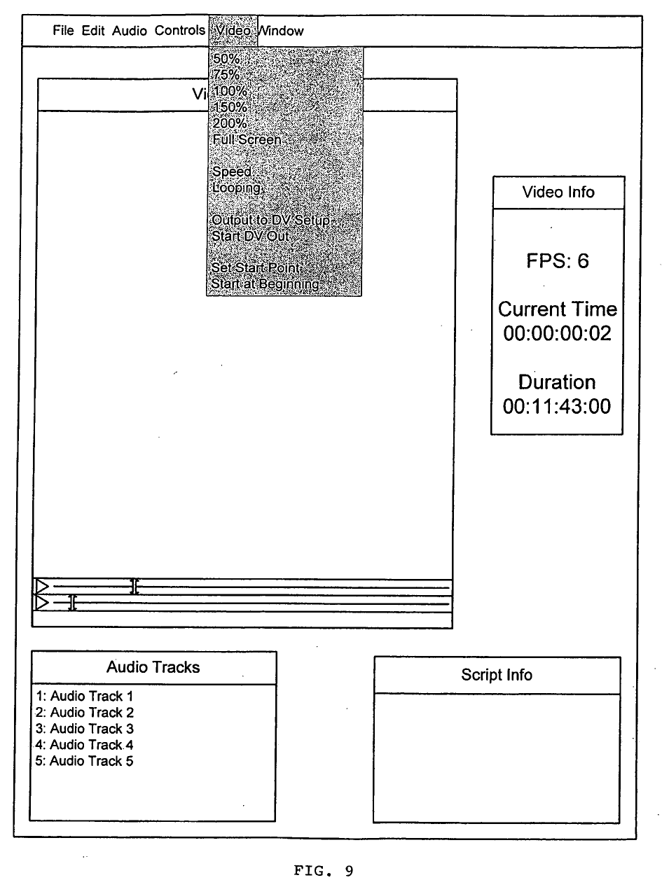

In FIG. 9, from the “Video” menu, the user may select magnifier ratios for the screen size from a drop-down list, as well as other video track control options.

In the figures, the primary two control components are displayed below the video playback display area, referred to as the “Video Window.” On the bottom right side is the “Script Info” window which displays the speed that the script is being played back at. The user can speed this up or slow it down by using arrow buttons at the bottom of the window to raise or lower the script playback speed. On the top right side is the “Video Info” window which displays the current (user controlled) frame per second playback rate, the location of the playback head in standard video time code, and the absolute length of the movie clip, if played back at normal video playback rate of 30 fps. On the bottom left side is the Audio Tracks selection box, from which the current audio track can be selected using number keyboard commands corresponding to the titles in the selection box. For example:

“1”—Select audio track 1 as the audible audio track.

“2”—Select audio track 2 as the audible audio track.

“3”—Select audio track 3 as the audible audio track.

“4”—Select audio track 4 as the audible audio track.

“5”—Select audio track 5 as the audible audio track.

Alternatively, audio tracks may be selected by clicking radio buttons next to or clicking on the linked titles appearing in the Audio Tracks selection box. Selection of a new audio track takes effect immediately. A short fade in/out period may be provided as the previous audio track is silenced and the newly selected audio track becomes audible. The new track selection is stored for later use in editing or playback.

Referring again to FIG. 2B, the typical operation of the system can be understood through an example illustrated in the state diagram (see Minimal State Diagram).

INIT State: The application software begins in the INIT state. Various variables are initialized at this point, including the Video_Playback_Rate variable, which is set to its default initial value, the Current_Audio_Track variable, which is set to one, the Video_Frame_Index variable, which is set to zero, and the Audio_Time_Index variable, which is set to zero. At this point, the initial display is presented to the user on the display device. The initial display consists of a menu, audio track selection window, video info window, and script info window. Once the system is initialized, the state transitions to the UNLOADED state.

UNLOADED State: From the UNLOADED state, the user can choose to load a video track or set the video playback rate. If the user chooses to set the video playback rate, the Set_Video_Playback_Rate function is invoked. If the user chooses to load a video track, the Load_Video_Track function is executed and the state transitions to the AUDIO PAUSED-VIDEO PAUSED state.

AUDIO PAUSED-VIDEO PAUSED State: In this state, the user may choose to load an audio track, set the video playback rate, change the currently selected audio track, set the video frame index, set the audio time index, play the audio, play the video, or play both the audio and video. If the user chooses to load an audio track, the Load_Audio_Track function is invoked. If the user chooses to set the video playback rate, the Set_Video Playback_Rate function is invoked. If the user changes the currently selected audio track, the Select_Current_Audio_Track function is invoked. If the user changes the video frame index, the Set_Video_Frame_Index function is invoked. If the user changes the audio time index, the Set_Audio_Time_Index function is invoked. If the user chooses to play both the audio and video, the state transitions to the AUDIO PLAYING-VIDEO PLAYING state. If the user chooses to play only the audio, the state transitions to the AUDIO PLAYING-VIDEO PAUSED state. If the user chooses to play only the video, the state transitions to the AUDIO PAUSED-VIDEO PLAYING state.

AUDIO PLAYING-VIDEO PLAYING State: In this state, the user may choose to load an audio track, set the video playback rate, select the current audio track, set the video frame index, set the audio time index, pause both the audio and video, pause only the audio, or pause only the video. If the user chooses to load an audio track, the Load_Audio_Track function is invoked. If the user chooses to set the video playback rate, the Set_Video_Playback_Rate function is invoked. If the user changes the currently selected audio track, the Select_Current_Audio_Track function is invoked. If the user changes the video frame index, the Set_Video_Frame_Index function is invoked. If the user changes the audio time index, the Set_Audio_Time_Index function is invoked. If the user chooses to pause both the audio and video, the state transitions to the AUDIO PAUSED-VIDEO PAUSED state. If the user chooses to pause only the audio, the state transitions to the AUDIO PAUSED-VIDEO PLAYING state. If the user chooses to pause only the video, the state transitions to the AUDIO PLAYING-VIDEO PAUSED state. If the last frame of video is played, the state transitions to the AUDIO-PLAYING-VIDEO PAUSED state. If the last frame of audio is played, the state transitions to the AUDIO PAUSED-VIDEO PLAYING state. If both the last frame of video and the last frame of audio are played at the same time, the state transitions to the AUDIO PAUSED-VIDEO PAUSED state.

AUDIO PAUSED-VIDEO PLAYING State: In this state, the user may choose to load an audio track, set the video playback rate, select the current audio track, set the video frame index, set the audio time index, play the audio, or pause the video. If the user chooses to load an audio track, the Load_Audio_Track function is invoked. If the user chooses to set the video playback rate, the Set_Video_Playback_Rate function is invoked. If the user changes the currently selected audio track, the Select_Current Audio_Track function is invoked. If the user changes the video frame index, the Set_Video_Frame_Index function is invoked. If the user changes the audio time index, the Set_Audio_Time_Index function is invoked. If the user chooses to play the audio, the state transitions to the AUDIO PLAYING-VIDEO PLAYING state. If the user chooses to pause the video, the state transitions to the AUDIO PAUSED-VIDEO PAUSED state. If the last frame of video is played, the state transitions to the AUDIO-PAUSED-VIDEO PAUSED state.

AUDIO PLAYING-VIDEO PAUSED State: In this state, the user may choose to load an audio track, set the video playback rate, select the current audio track, set the video frame index, set the audio time index, pause the audio, or play the video. If the user chooses to load an audio track, the Load_Audio_Track function is invoked. If the user chooses to set the video playback rate, the Set_Video_Playback_Rate function is invoked. If the user changes the currently selected audio track, the Select_Current_Audio_Track function is invoked. If the user changes the video frame index, the Set_Video_Frame_Index function is invoked. If the user changes the audio time index, the Set_Audio_Time_Index function is invoked. If the user chooses to pause the audio, the state transitions to the AUDIO PAUSED-VIDEO PAUSED state. If the user chooses to play the video, the state transitions to the AUDIO PLAYING-VIDEO PLAYING state. If the last frame of audio is played, the state transitions to the AUDIO-PAUSED-VIDEO PAUSED state.

In the described preferred embodiment, software objects, functions, methods, and APIs are used to implement the various actions which can be performed. The objects, functions, methods, and APIs are invoked in response to user input as described in the state diagram and user interface description.

Video Playback: Video playback is handled by a RealBasic MoviePlayer object. The Video_Playback_Loop function executes continuously whenever the system is in the AUDIO PAUSED-VIDEO PLAYING state or the AUDIO PLAYING-VIDEO PLAYING state. It is responsible for causing video frames to be sequentially displayed. The amount of time for which each frame is displayed is dependent on the Video_Playback_Rate variable, which is stored in units of frames per second. The frame display interval is therefore calculated as (1/Video_Playback_Rate). After each frame is displayed for the given time interval, the SetMovieTimeValue QuickTime API is used to update the movie playback position to display the next frame in the video movie.

Audio Playback: Although there is a video playback loop function, there is no corresponding audio playback loop function, as audio playback is handled automatically by the QuickTime system.

Load_Video_Track Function: This function presents the user with a list of video files contained on local and/or remote storage device(s) and allows the user to select a single video file from the list. The RealBasic GetOpenFolderItem method is used to present the dialog box to the user and obtain the folder selection from the user. This method returns a user selectable folder item which is passed to the RealBasic OpenAsMovie method to obtain a QuickTime movie object. The QuickTime movie object contains a QuickTime movie handle. This movie handle is used as to store the video track. A handle to a second QuickTime movie is then created using the NewMovie QuickTime API. This movie handle is used to store the audio tracks. If there are one or more audio tracks contained in the previously selected video file, they are each copied from the original video movie handle and attached to the newly created audio movie handle using the InsertMovieSegment QuickTime API. Once each audio track is copied, it is removed from the video movie handle using the DisposeMoveTrack QuickTime API. After each audio track is attached to the audio movie, it is marked as inaudible using the SetTrackEnabled QuickTime API. The currently selected audio track, as stored in the Current_Audio_Track variable is marked as audible using the SetTrackEnabled QuickTime API.

Load_Audio_Track Function: This function presents the user with a list of audio files contained on local and/or remote storage device(s) and allows the user to select a single audio file from the list. The RealBasic GetOpenFolderItem method is used to present the dialog box and obtain the folder selection from the user. This method returns a user selectable folder item which is passed to the RealBasic OpenAsMovie method to obtain a QuickTime movie object which contains a QuickTime movie handle. If there are one or more audio tracks contained in the selected audio file, they are each copied from the newly opened movie handle and attached to the existing audio movie handle using the InsertMovieSegment QuickTime API. After each audio track is attached to the audio movie, it is marked as inaudible using the SetTrackEnabled QuickTime API. The currently selected audio track, as stored in the Current_Audio_Track variable is marked as audible using the SetTrackEnabled QuickTime API.

Set_Video_Playback_Rate Function: This function is used to adjust the frame rate at which the video file is played back. The video file is composed of a sequence of pictures or video frames which are individually and sequentially displayed to the user within the video playback window. Each frame is displayed for a period of time which is controlled by the current setting of Video_Playback_Rate variable. The Set_Video_Playback_Rate function is used to set the Video_Playback_Rate variable.

Select_Current_Audio_Track Function: This function is used to select the currently audible audio track. Only one audio track can be audible at a given time, although a given audio track may contain multiple audio streams which are audible at the same time (for example, containing stereo or multi-track sound). The Select_Current_Audio_Track Function sets the Current_Audio_Track variable. All of the audio tracks in the audio movie are then changed to be inaudible using the SetTrackEnabled QuickTime API. The audio track which is indicated by the Current_Audio_Track variable (and only that audio track) is then set to be audible using the SetTrackEnabled QuickTime API.

Set_Current Video Frame Index Function: This function is used to set the Video_Frame_Index, thus specifying the frame of video which is to be displayed. The SetMovieTimeValue QuickTime API is used to update the movie playback position to the appropriate video frame.

Set_Current_Audio_Time_Index Function: This function is used to set the current position of the audio playback within the audio movie. The SetMovieTimeValue QuickTime API is used to update the movie playback position to the appropriate audio frame.

### Scripting for Editing And Playback

The editor/player application is able to record the user's actions and generate a script. The user initiates the recording using either a particular keyboard or mouse command. Once the recording is initiated, various events from that point forward are recorded, until such time as the user terminates the recording. Events which are recorded include such actions such as the user choosing to play the audio, pause the audio, play the video, pause the video, set the video playback rate, change the current audio track, set the video frame index, and set the audio time index.

When the user initiates the recording, the current time measured in clock ticks is stored in the Recording_Time variable. When each recordable event occurs, a Delta_Time is computed by subtracting the Recording_Time from the current time. Each recorded event is then stored in an array entry, along with any associated arguments which control the behavior of that event, as well as the event's computed Delta_Time.

When the user indicates that the recording is complete, the recording can be saved as a text-based script file. One line of text is output for each entry in the event array. Each line that is output contains the event type, one or more event arguments, and the event's associated Delta_Time.

Saved scripts can be replayed at a later time. When a script is loaded, it is stored in memory in the Playback array. Each line of text from the script is stored as a unique entry in the Playback array. The Playback_Index variable is used to track the next entry in the playback array, and it is initially set to zero. When the script is loaded, the current time measured in clock ticks is stored in the Playback_Time variable.

A timer is dispatched sixty times per second which causes the Playback_Timer function to execute. The Playback_Timer function parses the entry in the Playback array at the index of Playback_Index and retrieves the associated Delta_Time. It then compares the current time to the sum of the Playback_Time and the entry's Delta_Time. If the current time is greater than or equal to the sum, then the associated event is executed by calling the associated event function with the stored event parameters, and the Playback_Index is incremented. Playback continues until the last event in the Playback_Array is executed, at which point playback stops.

For producing a program for playback and/or subsequent editing, the control instructions for controlling the underlying video and audio resources are recorded as a control file that can be retrieved for playback or modification. The program can be distributed on a CD or DVD disc recorded with the editing/playback application and the underlying video and audio tracks. The disc can thus be distributed as a PC-operable program that can be played back and modified as the user desires, without needing to go through a multimedia editing system. The invention is particularly suitable for making personally editable music video and/or playing video games, audience participation (karaoke) games, and the like.

As a further development, the invention can be adapted for use on a network or the Internet. For example, video tracks and audio tracks (songs) stored on remote devices may be linked by file-sharing to the control interface of a user. In this manner, users on a network can share video and audio files and collaborate on creating multimedia programs for themselves as viewer-participants.

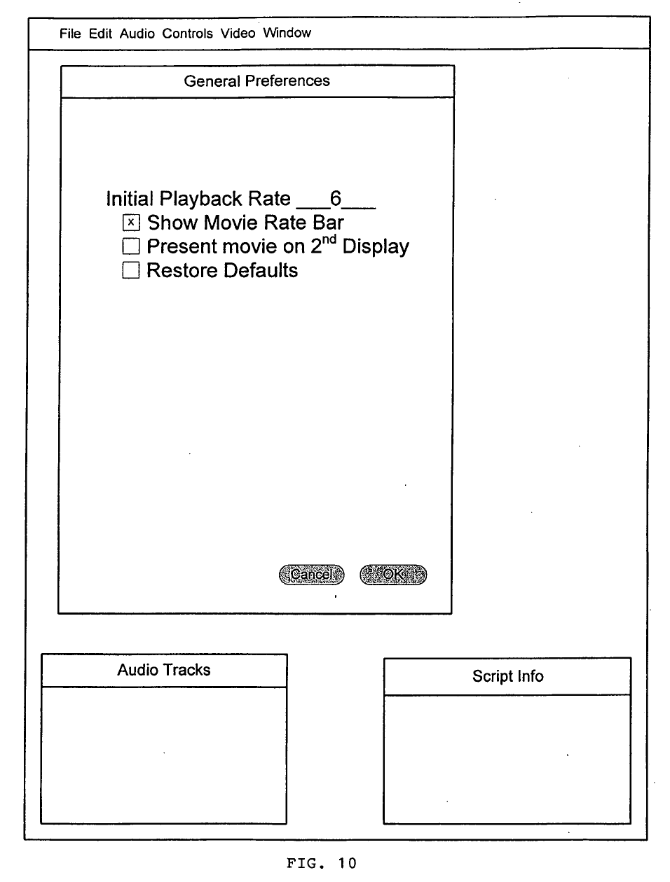

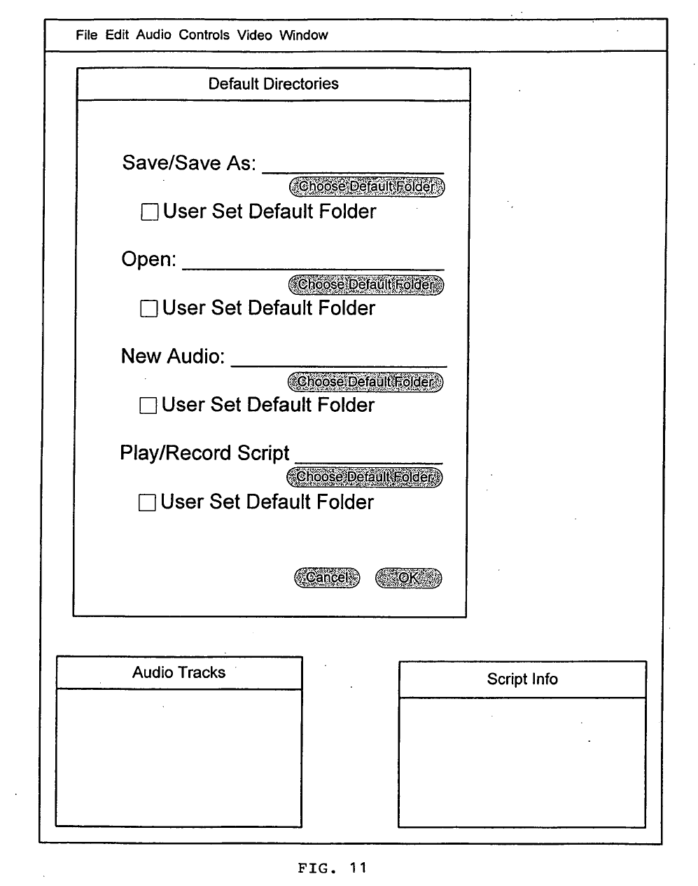

FIG. 10 illustrates a dialog box for setting general preferences for the audio-video program. The “General Preferences” dialog box allows the user to set the default playback rate in frames per second, to enable or disable the display of the movie rate bar, to select a secondary display device as the output window for the movie, and to restore the default preferences values. FIG. 11 illustrates a dialog box for setting Default Directories for the audio-video program. The “Default Directories” dialog box allows the user to set various default directories for loading and storing files.

### SUMMARY

The application described is novel in both its purpose and its implementation. A dual-control interface is used to adjust speed of an underlying video resource in real time independently of the audio, while simultaneously the user can select any audio in real time from among multiple audio tracks. The user is provided with the ability to create a unique audio-visual experience which can not be created using existing methods. Pre-recorded video speed and audio selection commands can be distributed on a disc with the audio-video system application and underlying video and audio tracks for play on PCs or game consoles, or thin clients such as mobile devices, Internet browsers, etc. The user can compose and play the audio-video resources extemporaneously, or edit a work, re-edit or playback a pre-recorded work, without needing to make modifications through an editing system. AUDIO/VIDEO programs can be made self-contained and played or operated in any desired mode on any type of compatible device, as well as broadcast, cablecast, podcast programs, etc.

It is understood that many modifications and variations may be devised given the above description of the principles of the invention. It is intended that all such modifications and variations be considered as within the spirit and scope of this invention, as defined in the following claims.

1. An audio-video system operable on a computer device comprising:
a) a video controller for running an underlying video resource composed as a series of digital image frames of visual content for video output;
b) an audio controller for running a plurality of underlying audio resources and selectively switching among them for audio output, wherein any one of the underlying audio resources can be selectively switched by the audio controller for audio output; and
c) a dual-control interface operable by a user of the system for controlling the underlying video resource and plurality of audio resources, wherein said dual-control interface includes a video speed control for providing a video speed command to the video controller for adjusting the running speed of digital image frames of visual content from the video resource at any point in time, and an audio selection control for providing an audio selection command to the audio controller for selectively switching to any one of the plurality of underlying audio resources for audio output at any point in time independently of the video speed control.

2. The audio-video system according to claim 1, wherein the video speed and audio selection commands input through the control interface are recorded as an output file for later playback.

3. The audio-video system according to claim 2, wherein during playback mode, the recorded video speed and audio selection commands are played back and used to control the underlying video and audio resources in real-time.

4. The audio-video system according to claim 1, wherein the dual-control interface is operated by a user for extemporaneously composing an audio-visual program.

5. The audio-video system according to claim 1, wherein the video resource is video content that is captured or converted to a video file in digital format.

6. The audio-video system according to claim 1, wherein the audio resources are audio content that are captured or converted to audio files in digital format.

7. The audio-video system according to claim 1, wherein the video speed control of the dual-control interface adjusts the speed of the video resource to aesthetically match any one of the plurality of audio resources selected at different points in time.

8. The audio-video system according to claim 1, wherein the audio resources include live microphone input.

9. The audio-video system according to claim 1, wherein the audio resources include long-format audio or looped tracks.

10. The audio-video system according to claim 9, wherein the audio resources are cued to start together at the same time so that the user can quickly switch from one audio track to another at different points in time of the running of the video resource.

11. The audio-video system according to claim 1, wherein the video resource is composed of still-image frames from stop-motion photography.

12. The audio-video system according to claim 1, wherein the video speed and audio selection commands and underlying video and audio resources are recorded on disks for operation on PCs or games consoles.

13. The audio-video system according to claim 1, wherein the video speed and audio selection commands and underlying video and audio resources are recorded for use on mobile devices or Internet browsers.

14. The audio-video system according to claim 1, adapted for use on a network or the Internet, wherein the video and audio resources are stored on remote devices and linked by file-sharing to the control interface of a user.

15. A method of selectively operating audio and video resources in editing and playback modes comprising:
a) running an underlying video resource composed as a series of digital image frames of visual content for video output;
b) running a plurality of underlying audio resources and selectively switching among them for audio output, wherein any one of the underlying audio resources can be selectively switched by the audio controller for audio output; and
c) controlling the underlying video resource and plurality of audio resources by providing a video speed command for adjusting the running speed of digital image frames of visual content from the video resource at any point in time, and providing an audio selection command for selectively switching to any one of the plurality of underlying audio resources for audio output at any point in time independently of the video speed control.

16. The audio-video method according to claim 15, further including recording the video speed and audio selection commands as an output file for later playback.

17. The audio-video method according to claim 16, wherein during playback mode, the recorded video speed and audio selection commands are played back and used to control the underlying video and audio resources in real-time.

18. The audio-video method according to claim 15, wherein the video speed and audio selection commands are generated by a user for extemporaneously composing an audio-visual program.

19. The audio-video method according to claim 15, wherein the video speed and audio selection commands and underlying video and audio resources are recorded on disks for operation on PCs or games consoles.

20. The audio-video method according to claim 15, wherein the video speed and audio selection commands and underlying video and audio resources are recorded for use on mobile devices or Internet browsers.
